(19) United States
(12) Patent Application Publication
(10) Pub. No.: US 2009/0049208 A1
(43) Pub. Date: Feb. 19, 2009

(54) Media Processing Device and Control Method for a Media Processing Device

(75) Inventors: Hideki Nishimura, Nagano-ken (JP); Yoshiaki Kinoshita, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/188,733

(22) Filed: Aug. 8, 2008

(30) Foreign Application Priority Data
Aug. 14, 2007 (JP) 2007-211435

(51) Int. Cl. G06F 3/00

(52) U.S. Cl. 710/19

(57) ABSTRACT

When USB communication between a host computer and media processing device is interrupted while processing media, sending useless read data to the host computer is prevented. A control method for a media processing device 1 that is connected by a USB cable to a host computer 30, reads information continuously from a plurality of slips S according to instructions from the host computer 30, and sends the read information to the host computer 30 has steps of monitoring the communication state between the host computer 30 and the media processing device 1, interrupting the continuous reading process by executing a software reset process when communication becomes disabled while the continuous reading process is running (step S25 returns Yes), and deleting read data that has not been sent to the host computer 30 (step S26).

### CROS-REFERENCE TO RELATED APPLICATIONS

Japanese Patent application No. 2007-211435 is hereby incorporated by reference in its entirety.

### BACKGROUND

1. Field of Invention

The present invention relates to a media processing device that is connected through a USB interface to communicate with a host computer, reads information continuously from a plurality of processed media in response to instructions from the host computer, and then sends the read information to the host computer. The invention also relates to a control method for the media processing device.

2. Description of Related Art

Technologies for electromagnetically reading checks have been developed in order to improve the efficiency of check processing. Disposed along the paper transportation path through which the checks are conveyed, a check processing device typically has an image reading means (image scanner) that images the conveyed checks, a magnetic ink character reader (MICR reader) that reads information written in magnetic ink on the checks, a communication unit that sends the image data and MICR data captured by these readers to the host computer, and a printing means that prints information such as an endorsement on the back of the processed checks.

When a bank teller, for example, receives a check from a customer and passes the check through the check processing device, the check processing device typically continuously images and reads the magnetic ink character line continuously from a plurality of checks in response to read commands from the host computer, and sends the captured image data and magnetic ink character data to the host computer when reading is completed.

The Universal Serial Bus (USB) is a commonly used serial interface standard for computer systems. Using standardized connectors, USB cables are widely used to connect personal computers and peripheral devices such as printers, keyboards, mice, and storage devices.

USB devices are so-called plug-and-play (PnP) devices that automatically connect to the system so that the user does not need to configure the peripheral device to match the host or restart the host in order to recognize the peripheral device. When a USB device is connected to a host computer, the host and device communicate by USB through the USB connectors and the host recognizes the type of USB device. The host then loads a driver appropriate to the USB device, and configures the system for USB communication. The host then continues to communicate with the USB device as needed for as long as communication remains possible.

More specifically, the plug-and-play recognition operation starts when the USB cable is connected or the power to a connected USB device is turned on, and the USB device is recognized. Japanese Unexamined Patent Appl. Pub. JP-A-2006-171868 teaches a printer that resets USB communication without needing to disconnect and reconnect the USB cable. If a communication error occurs during USB communication between the printer and host computer, the print data buffered to the printer is cleared and the printer is disconnected virtually in order to automatically recover from the communication error.

Japanese Unexamined Patent Appl. Pub. JP-A-2006-294064 teaches a system in which the communication protocol on the host computer side deletes the print job and the communication protocol on the printer side clears the buffer when the communication cable is disconnected so that communication is disabled and both the host computer and printer detect that the communication cable is not connected. By deleting the data on both the host computer and printer sides, printing is not wasted.

A check reading process that can be used when the check processing device described above is connected as a USB device to the host computer by means of a USB cable is described below with reference to FIG. 4.

If the operator selects the reading speed priority mode for the continuous reading process, the host computer generates and sends an operating condition configuration command setting the operating conditions to the check processing device (media processing device) (step S31). If the check processing device determines the data sent from the host computer is the operating condition configuration command, the check processing device sets the discharge process for each check in the continuous reading process (step S41).

The host computer then generates and sends a continuous read command for the checks to the media processing device (step S32). When the media processing device receives the continuous read command, it advances the first check and returns a start feeding status report. The check is then imaged by the image scanner (step S42) and the MICR line of the check is read by the MICR reader (step S43). The read information is then sent from the media processing device to the host computer (step S44). When the read process ends, a reading completed status report is sent to the host computer.

The read results for particular read items are then evaluated (step S45), and the discharge process is executed based on the evaluation result according to the operating conditions set in step S41 (step S46). More specifically, if the VOID or ELECTRONIC FUNDS TRANSFER stamp is to be applied, the stamp is pressed to the face of the check and the check is then discharged into the discharge unit. The check is discharged into the discharge path of the discharge unit set by the operating condition configuration command. When discharging the first check is completed, the media processing device sends a discharge completed status report to the host computer.

If the continuous reading process is set to continue (step S47 returns Yes), and the read process has not been completed for all checks (step S48 returns No), the next check is conveyed (step S49), and steps S42 to S48 repeat. When the read process has been completed for all checks in step S48 (step S48 returns Yes), a continuous reading process completion report is sent to the host computer and the continuous reading process ends (step S50).

When the host computer detects the continuous reading process completion report in the data sent from the media processing device (step S33), the host computer ends the continuous reading process for the checks.

If the USB cable connecting the host computer and the media processing device is disconnected during the continuous reading process in step S44, communication is interrupted. When the USB cable is then reconnected and communication from the host computer resumes, the media processing device attempts to send the read data that was left unsent when communication was interrupted and which could be large to the host computer. However, if the media processing device does not detect that the USB cable was disconnected, the reading process continues needlessly. The number of checks that must be reprocessed therefore also increases unnecessarily.

The problem described above has also been shown to exist when the media processing device is connected to a host computer that is running the recently released Windows Vista® operating system. This is because the power management function of Windows Vista® can unconditionally cause the host computer to enter a sleep mode even though an application is running. Conventionally, however, the application could reject the sleep command from the OS, and the host computer would therefore not unconditionally go to sleep and communication would not be interrupted.

In Windows Vista®, however, applications cannot reject a sleep command, the host computer therefore enters the sleep mode, and the USB connection is interrupted. For the media processing device, this is the same as the USB cable being disconnected. More particularly, if the host computer enters the sleep mode and communication is interrupted while the media processing device is running the continuous reading process, the reading process continues needlessly. When the host computer wakes up from the sleep mode and attempts to resume communication, the media processing device tries to send the remaining unsent read data to the host computer.

### SUMMARY OF INVENTION

The present invention is directed to solving the foregoing problem and prevents sending unusable read data to the host computer when USB communication between the host computer and media processing device is interrupted during the continuous media reading process.

A first aspect of the invention is a media processing device that is communicably connected to a host computer, reads information continuously from a plurality of processed media according to instructions from the host computer, and sends the read information to the host computer, the media processing device having a communication state management unit that monitors the communication state between the host computer and the media processing device; a status management unit that instructs interrupting the continuous reading process when communication with the host computer becomes disabled while the continuous reading process is running; and a reading control unit that deletes read data that has not been sent to the host computer.

Another aspect of the invention is a control method for a media processing device that is communicably connected to a host computer, reads information continuously from a plurality of processed media according to instructions from the host computer, and sends the read information to the host computer, the control method including steps of monitoring the communication state between the host computer and the media processing device; interrupting the continuous reading process when communication with the host computer becomes disabled while the continuous reading process is running; and deleting read data that has not been sent to the host computer.

By monitoring communication between the host computer and media processing device, the media processing device can detect when communication has been disabled while executing a continuous reading process because communication was interrupted. Furthermore, by interrupting the continuous reading process after detecting that communication is disabled, the reading process is prevented from continuing unnecessarily, and an increase in the number of processed media that must be reprocessed can be prevented. In addition, by deleting any data that has been read but not sent to the host computer when disruption of communication is detected, sending useless read data to the host computer can also be prevented.

Furthermore, because applications running under the Windows Vista (R) operating system cannot override a sleep command, the host computer enters the sleep mode unconditionally when instructed by the operating system and the USB connection is therefore interrupted, a media processing device according to the present invention recognizes this situation as being identical to the USB cable being unplugged. More specifically, if the host computer enters the sleep mode and communication is interrupted while the media processing device is executing the continuous reading process, the media processing device detects that communication has been disabled, and can therefore interrupt the continuous reading process in progress and delete read data that has not been sent to the host computer.

In a media processing device according to another aspect of the invention the reading control unit executes a software reset process in response to a communication disabled report.

In a control method for a media processing device according to another aspect of the invention a software reset process is executed in response to a communication disabled report when communication with the host computer becomes disabled while the continuous reading process is running.

By executing a software reset process in response to a communication disabled report, the read data stored on the media processing device can be batch deleted. Needlessly reading and dropping the read information is therefore prevented. In addition, by executing a software reset, the media processing device can omit part of the hardware check when restarting and can therefore restart quickly.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic diagram of the paper transportation path in a media processing device according to a preferred embodiment of the invention.

FIG. 2 is a function block diagram of a media processing system including a host computer according to a preferred embodiment of the invention.

FIG. 3 is a flow chart describing the reset process executed by the media processing device according to the preferred embodiment of the invention.

FIG. 4 is a flow chart describing the check reading process using USB communication when a check processing device is connected as a USB device to the host computer.

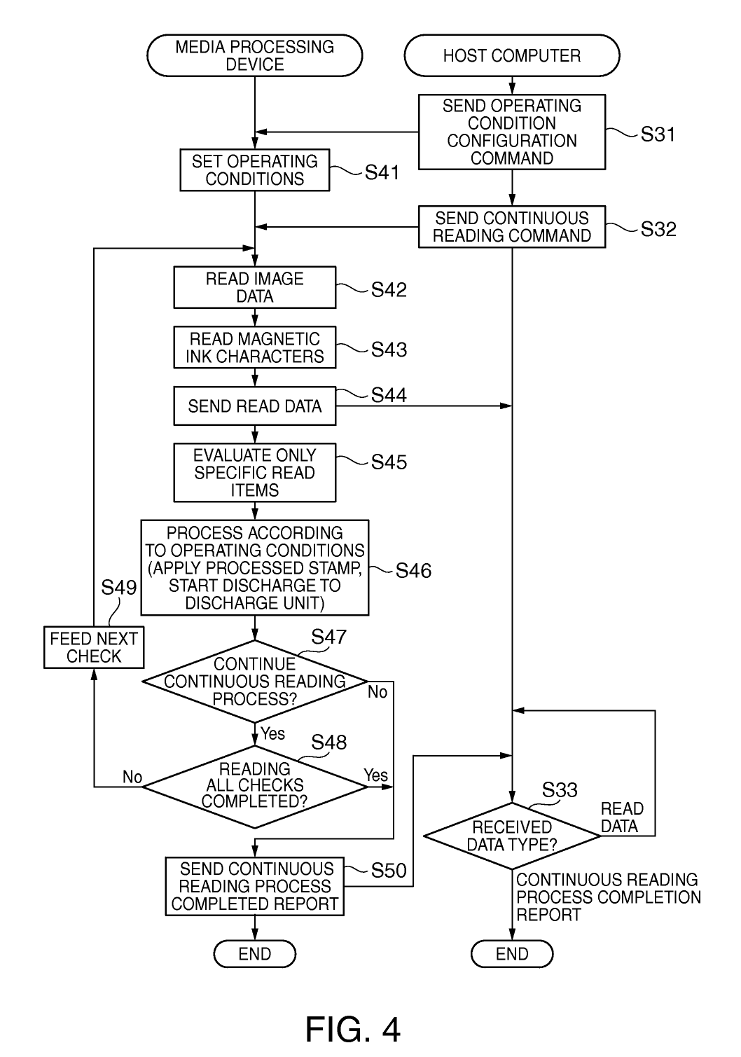

### DESCRIPTION OF THE PREFERRED EMBODIMENTS

A preferred embodiment of a media processing device according to the present invention is described below with reference to the accompanying figures.

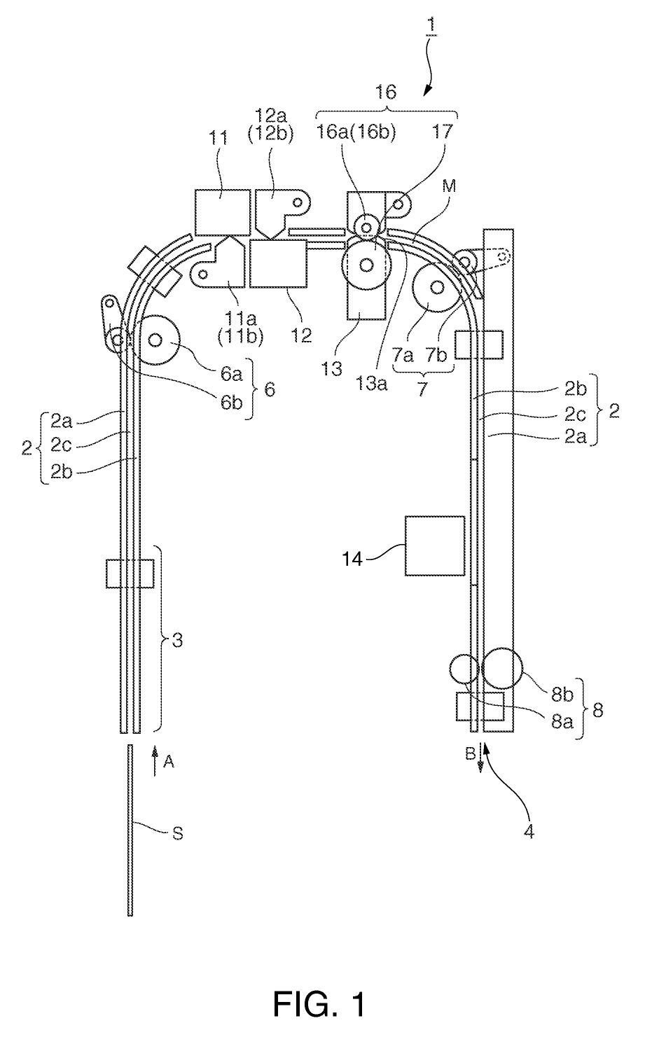

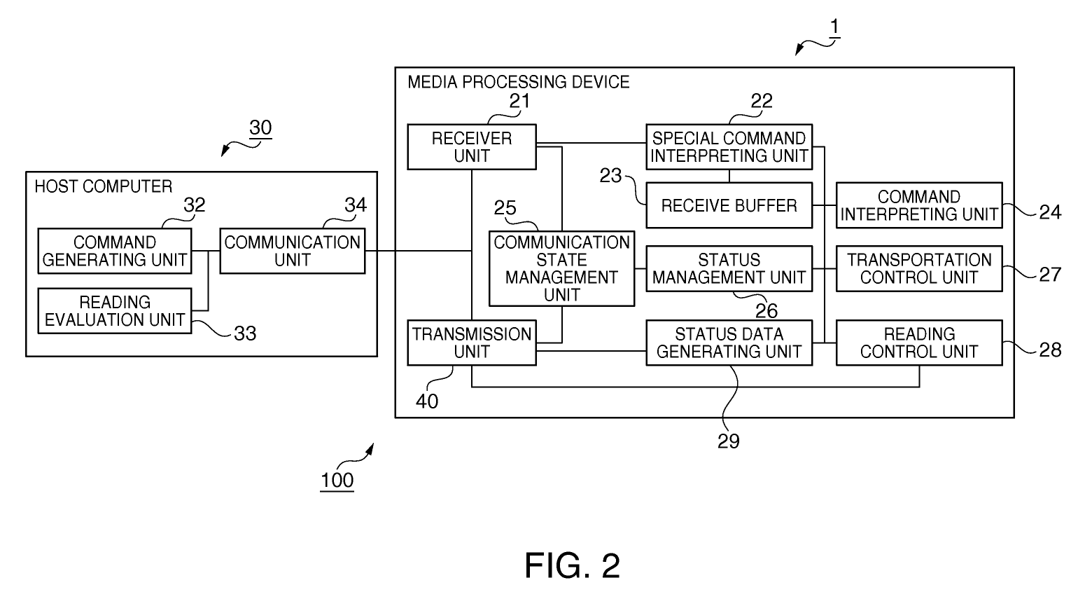

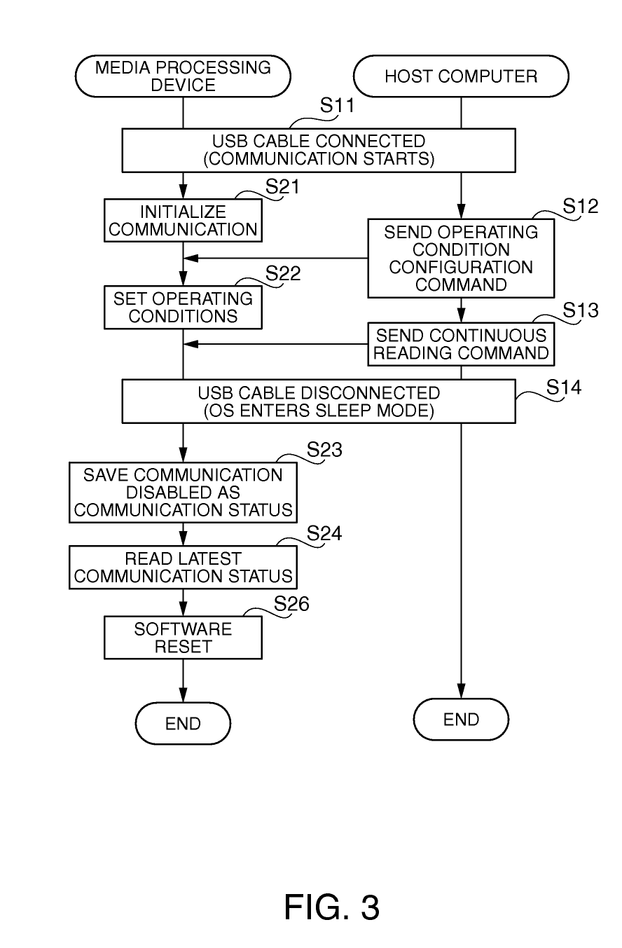

FIG. 1 is a schematic diagram of the paper transportation path in a media processing device according to a preferred embodiment of the invention. FIG. 2 is a function block diagram of a media processing system including a host computer. FIG. 3 is a flow chart describing the reset process executed by the media processing device shown in FIG. 1.

The media processing system 100 according to this preferred embodiment of the present invention includes a host computer 30 and a media processing device 1. The media processing device 1 applies prescribed processes according to commands received from the host computer 30 to check S, stubs, and other slips conveyed through the paper transportation path 2 of the media processing device 1.

The media processing device 1 is a terminal device that is used at a teller window, for example, where slips (processed media) S such as checks and stubs are processed, and images both sides of the slips S and reads magnetic ink characters from the slips S while conveying the slips S (process media) that are loaded into an automatic sheet feeder (ASF) 3, which is disposed as a paper supply unit, through a paper transportation path 2.

The slips S transportation path 2 is substantially U-shaped, and has a middle transportation path M in the portion corresponding to the bottom of the U. Various reading devices are disposed to this middle transportation path M.

The paper transportation path 2 includes a conveyance portion 2c between an outside guide 2a and an inside guide 2b, and the slips S are conveyed along this conveyance portion 2c.

An automatic sheet feeder 3 that holds multiple slips S is disposed to the upstream end of the paper transportation path 2. The plural slips S are inserted in the direction of arrow A by the automatic sheet feeder 3 to the paper transportation path 2. The plural slips S loaded in the automatic sheet feeder 3 are separated and fed one at a time into the paper transportation path 2.

Disposed as a transportation means for conveying the checks S through the paper transportation path 2 are a first paper transportation roller pair 6 on the upstream side of the middle transportation path M, a middle transportation roller set 16 disposed in the middle of the middle transportation path M, a second transportation roller pair 7 on the downstream side of the middle transportation path M, and a discharge roller pair 8 located before the exit 4.

The paper transportation roller pair 6 includes a drive roller 6a and a pressure roller 6b located on the other side of the paper transportation path 2 opposite the drive roller 6a.

The second transportation roller pair 7 includes a drive roller 7a and a pressure roller 7b located on the other side of the paper transportation path 2 opposite the drive roller 7a.

The middle transportation roller set 16 includes a lower pressure roller 16a disposed to the lower part of the paper transportation path 2, an upper pressure roller 16b disposed above the lower pressure roller 16a, and a drive roller 17 located on the other side of the middle transportation path M opposite the lower pressure roller 16a and upper pressure roller 16b.

Slips S that are fed from the automatic sheet feeder 3 into the paper transportation path 2 are conveyed by the first paper transportation roller pair 6, the middle transportation roller set 16, and the second transportation roller pair 7 through the middle transportation path M, and are then discharged in the direction of arrow B by the discharge rollers 8.

A first image scanner 11 and a second image scanner 12 for imaging (capturing image data from) both sides of the slips S are disposed on opposite sides of the middle transportation path M at offset positions in the paper transportation direction.

The first and second image scanners 11 and 12 are CIS (contact image sensor) type scanners. The image scanners 11 and 12 each emit light to one side of each sheet medium S conveyed through the middle transportation path M, sense the light reflected from the media using a plurality of photosensors (photoelectric conversion elements), convert the light to electric signals, and capture one line of the complete image. In this embodiment of the invention the first image scanner 11 images the back of each sheet medium S and the second image scanner 12 images the front of each sheet medium S one line at a time to acquire a two-dimensional image of the sheet medium S.

The MICR (magnetic ink character recognition) reader 13 for reading information (such as magnetic ink characters) recorded using magnetic ink on the slips S is located below the drive roller 17. The MICR reader 13 reads the magnetic ink characters with the sheet medium S pressed against the surface of the MICR reader 13 by means of a pressure lever 61 disposed on the other side of the middle transportation path M opposite the MICR reader 13.

A stamping mechanism 14 is disposed to the paper transportation path 2 between the second transportation roller pair 7 and the discharge roller pair 8. If reading the check is successfully completed, the stamping mechanism 14 stamps ELECTRONIC FUNDS TRANSFER or similar content indicating that the check was processed electronically on the face of the check S, for example. The stamping mechanism 14 stamps the front or back of the check S just before it is discharged into a discharge tray not shown. When the check S is imaged and the magnetic ink characters are read by the respective readers, the stamping mechanism 14 applies a stamp indicating that the check was successfully digitized.

Operation of the various parts of the media processing device 1 described above is controlled based on firmware that is preinstalled in a program recording unit in the media processing device, interprets commands sent from the host computer 30 and executes the processes corresponding to the commands from the host computer 30.

Internal Processing by the Media Processing Device

The internal processes of the media processing device 1 are described next with reference to FIG. 2.

The media processing device 1 has a receiver unit 21, a special command interpreting unit 22, a receive buffer 23, a command interpreting unit 24, a communication state management unit 25, a status management unit 26, a transportation control unit 27, a reading control unit 28, a status data generating unit 29, and a transmission unit 40.

The status management unit 26 centrally controls the overall operation of the media processing device 1. The status management unit 26 monitors the other units, and the status data generating unit 29 generates status data if there is a change in status. The status data includes, for example, a start feeding report, a reading completed report, and a discharge completed report. The output status reports are sent through the transmission unit 40 to the host computer 30.

The receiver unit 21 and transmission unit 40 are an interface for receiving data sent from the host computer 30 and sending data. The media processing device 1 according to this embodiment of the invention is a USB device that is connected by a USB cable to the host computer, and the media processing device 1 and host computer communicate using the USB standard.

If the data received by the receiver unit 21 is a special command, the command is interpreted by the special command interpreting unit 22, and if the received data is not a special command, the data is temporarily stored in the receive buffer 23. The command interpreting unit 24 sequentially reads and interprets the data stored in the receive buffer 23, and the status management unit 26 issues instructions to the control units according to the interpreted command.

If the command interpreting unit 24 determines that the received data is a continuous read command, the status management unit 26 issues instructions to the transportation control unit 27 and reading control unit 28 to apply the continuous reading process to the checks S. More specifically, commands for imaging the front and back of the checks S and reading the MICR line of each check are asserted.

The communication state management unit 25 monitors the communication state of the USB interface unit rendered by the receiver unit 21 and transmission unit 40. If the communication state management unit 25 detects that USB communication is disabled (such as because the USB cable was disconnected or the operating system entered a sleep mode) while the continuous reading process is processing a slip, the communication state management unit 25 sets the communication status to DISABLED in a register not shown and notifies the status management unit 26. The status management unit 26 then instructs the transportation control unit 27 and reading control unit 28 to interrupt processing the slips S.

The reading control unit 28 reads information by means of the image scanners 11 and 12 and the MICR reader 13. The image data from the slips S captured by the image scanners 11 and 12, and the magnetic ink character data read by the MICR reader 13 is sent through the transmission unit 40 to the host computer 30. When the communication state management unit 25 detects that USB communication is disabled, the reading control unit 28 also executes a software reset process.

This software reset process causes the media processing device 1 to interrupt the continuous reading process being executed and deletes any data that has been read but has not yet been sent to the host computer 30.

Internal Processing by the Host Computer

Internal processing by the host computer 30 is described next. The host computer 30 operates using Windows Vista® as the operating system. As known from the literature, Windows Vista® has a power management function and applications cannot reject a sleep command from the operating system causing the host computer to enter a sleep mode. As a result, the USB connection is interrupted by the host computer unconditionally entering the sleep mode, and the media processing device 1 recognizes this interruption in the same way as when the USB cable is disconnected. The media processing system 100 according to this embodiment of the invention can handle unexpected situations such as the USB cable being physically disconnected and the sleep mode being entered by the Windows Vista® operating system.

The sleep mode as used herein is an energy-saving mode that is entered after saving status information and data from a currently executing operation to a hard disk drive (not shown in the figure) of the host computer 30 so that when the host computer 30 wakes from the sleep mode again (the power turns on) the state and data that were saved before the energy-saving mode was entered can be restored from the hard disk drive, for example.

As shown in FIG. 2, the host computer 30 has a command generating unit 32, a reading evaluation unit 33, and a communication unit 34.

The command generating unit 32 generates commands causing the media processing device 1 to execute various operations. One such command is a continuous read command for conveying a plurality of slips S loaded in the automatic sheet feeder 3 through the transportation path, imaging the checks S by means of the first and second image scanners 11 and 12, and reading the magnetic ink characters by means of the MICR reader 13. The command generating unit 32 also generates operating condition configuration commands that set the discharge process in the continuous reading process according to the result of reading individual slips S.

The reading evaluation unit 33 recognizes the read information sent from the media processing device 1. More specifically, the reading evaluation unit 33 determines the quality (CAR/LAR, IQA, for example) of the image data captured by the image scanners 11 and 12, executes an optical character recognition (OCR) process, and applies a MICR process to the data read by the MICR reader 13.

The communication unit 34 is an interface for communicating with the media processing device 1. The communication unit 34 outputs commands generated by the command generating unit 32, and receives the read information sent from the media processing device 1.

Software Reset Process

The software reset process that is run in the media processing system 100 described above is described next with reference to the flow chart in FIG. 3. FIG. 3 is a flow chart describing the software reset process executed by the media processing device.

When the host computer 30 and media processing device 1 are connected by a USB cable and the operating system (Windows Vista®) of the host computer 30 is not in the sleep mode, the media processing device 1 is started. The host computer 30 and media processing device 1 communicate by USB communication through the USB connectors, and thus render a USB communication system (step S11). The communication state management unit 25 then initializes the communication status (step S21). The communication status is initialized to COMMUNICATION DISABLED. After the host computer 30 recognizes the type of USB device and loads the driver for the media processing device 1, the communication status is changed to COMMUNICATION ENABLED.

If the operator selects the reading speed priority mode in the continuous reading process, the command generating unit 32 of the host computer 30 generates and sends an operating condition configuration command setting the operating conditions through the communication unit 34 to the media processing device 1 (step S12). If the command interpreting unit 24 of the media processing device 1 determines the data sent from the host computer 30 is the operating condition configuration command, it sets the discharge process for each slip S in the continuous reading process (step S22).

The command generating unit 32 of the host computer then generates and sends a continuous read command for the slips S to the media processing device 1 (step S13). When the media processing device 1 receives the continuous read command, it advances the first slip S and returns a start feeding status report. After imaging slips S by the image scanners 11 and 12 (step S22) and reading the MICR line of the slips S by the MICR reader 13 starts, USB communication is interrupted as a result of the USB cable of the media processing device 1 being unplugged (or the operating system entering the sleep mode) (step S14).

The communication state management unit 25 that monitors the communication status with the host computer 30 thus determines that either the USB cable was unplugged or the operating system of the host computer entered the sleep mode because there is no communication from the host computer 30 to the media processing device 1. When the communication state management unit 25 thus detects that communication is not possible, it saves COMMUNICATION DISABLED as the communication status in a register, and passes this communication status to the status management unit 26 (step S23).

When the status management unit 26 receives this notice, it reads the latest communication status from the register (step S24). Because the stored communication status is COMMUNICATION DISABLED, the status management unit 26 tells the transportation control unit 27 and reading control unit 28 that communication is not possible, and interrupts the slip S reading process.

When the reading control unit 28 receives this COMMUNICATION DISABLED report, it applies a software reset to the media processing device 1 (step S26).

By applying a software reset, data that was read and stored in the media processing device 1 but not yet sent to the host computer 30 by the reading process can be deleted. Because any read data stored in the media processing device 1 is thus cleared, the media processing device 1 is prevented from sending useless data to the host computer 30 when the USB cable is reconnected and communication from the host computer 30 is received.

If the operating system of the host computer 30 had entered a sleep mode, the media processing device 1 is also prevented from sending useless data to the host computer 30 after the host computer 30 wakes from the sleep mode.

Furthermore, by thus applying a software reset, the continuous reading process can be quickly interrupted after the USB cable is unplugged in step S14. Needlessly continuing the reading process is therefore prevented, and the number of slips S that must be reprocessed can be prevented from increasing unnecessarily.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A media processing device that is communicably connected to a host computer, reads information continuously from a plurality of processed media according to instructions from the host computer, and sends the read information to the host computer, the media processing device comprising:
a communication state management unit that monitors the communication state between the host computer and the media processing device;
a status management unit that instructs interrupting the continuous reading process when communication with the host computer becomes disabled while the continuous reading process is running; and
a reading control unit that deletes read data that has not been sent to the host computer.

2. The media processing device described in claim 1, wherein:
the reading control unit executes a software reset process in response to a communication disabled report.

3. The media processing device described in claim 1, wherein:
the communication state management unit sends a communication disabled report to the status management unit when disconnection of a cable connecting the host computer is detected.

4. The media processing device described in claim 1, wherein:
the communication state management unit sends a communication disabled report to the status management unit when the communication state management unit detects that the operating system of the host computer has entered a sleep mode.

5. The media processing device described in claim 1, wherein:
the status management unit reports interruption of the continuous reading process to the reading control unit when a report is received from the communication state management unit.

6. The media processing device described in claim 1, wherein:
the media processing device and the host computer communicate using the Universal Serial Bus (USB) protocol.

7. A control method for a media processing device that is communicably connected to a host computer, reads information continuously from a plurality of processed media according to instructions from the host computer, and sends the read information to the host computer, the control method comprising steps of:
monitoring the communication state between the host computer and the media processing device;
interrupting the continuous reading process when communication with the host computer becomes disabled while the continuous reading process is running; and
deleting read data that has not been sent to the host computer.

8. The control method for a media processing device described in claim 7, wherein:
when communication with the host computer becomes disabled while the continuous reading process is running, a software reset process is executed in response to a communication disabled report.

9. The control method for a media processing device described in claim 7, wherein:
the communication disabled state is when a cable connecting the host computer is disconnected.

10. The control method for a media processing device described in claim 7, wherein:
the communication disabled state is when the operating system of the host computer has entered a sleep mode.
